(19) United States
(12) Patent Application Publication
(10) Pub. No.: US 2024/0123842 A1
(43) Pub. Date: Apr. 18, 2024

(54) VEHICLE

(71) Applicant: TOYOTA JIDOSHA KABUSHIKI KAISHA, Toyota-shi (JP)

(72) Inventors: Jin KOBAYASHI, Nagoya-shi (JP); Kota NAITO, Nagoya-shi (JP)

(73) Assignee: TOYOTA JIDOSHA KABUSHIKI KAISHA, Toyota-shi (JP)

(21) Appl. No.: 18/364,687

(22) Filed: Aug. 3, 2023

(30) Foreign Application Priority Data
Oct. 17, 2022 (JP) 2022-166244

(51) Int. Cl. B60L 53/10; B60L 53/66

(52) U.S. Cl. CPC B60L 53/11; B60L 53/66; B60L 2210/30; B60L 2270/38

(57) ABSTRACT

The vehicle includes a charger used for charging the power storage device, a first control device, and a second control device. The first control device communicates with the charging station. The second control device communicates with the charger and communicates with the first control device.

### CROSS-REFERENCE TO RELATED APPLICATION

This application claims priority to Japanese Patent Application No. 2022-166244 filed on Oct. 17, 2022, incorporated herein by reference in its entirety.

### BACKGROUND

### 1. Technical Field

The present disclosure relates to a vehicle.

### 2. Description of Related Art

Conventionally, it has been proposed that a vehicle of this type includes a charger used for charging a power storage device, and can perform direct current (DC) charging for charging the power storage device using direct current power from a DC charging station and alternating current (AC) charging for charging the power storage device by converting alternating current power from an AC charging station into direct current power with the charger (see, for example, Japanese Unexamined Patent Application Publication No. 2018-157718 (JP 2018-157718 A)). In this vehicle, a control device that controls the charger communicates with a server outside the vehicle via a communication device. The server communicates with the DC charging station.

### SUMMARY

When a control device communicates with a charger and communicates with a server outside a vehicle, in communication between the vehicle and the server, from an entry point in the vehicle, a first layer is the control device, and a second layer is the charger. Therefore, there is a concern that the charger is also exposed to an attack from the outside.

A main object of the vehicle according to the present disclosure is to provide security protection for the charger.

The vehicle according to the present disclosure adopts the following means in order to achieve the above-described main object.

A vehicle according to the present disclosure is a vehicle that is able to perform direct current charging for charging a power storage device using direct current power from a direct current charging station and alternating current charging for charging the power storage device by converting alternating current power from an alternating current charging station into direct current power with a charger.

The vehicle includes:
a charger used for charging the power storage device;
a first control device; and
a second control device.

The first control device communicates with the charging station; and
the second control device communicates with the charger and communicates with the first control device.

The vehicle according to the present disclosure includes the charger, the first control device, and the second control device. The first control device communicates with the charging station. The second control device communicates with the charger and communicates with the first control device. Therefore, in communication between the vehicle and the charging station, from an entry point in the vehicle, a first layer becomes the first control device, a second layer becomes the second control device, and a third layer becomes the charger. As a result, the security of the charger can be protected as compared with a case where the first layer from the entry point is either the first control device or the second control device, and the second layer from the entry point becomes the charger.

In the vehicle according to the present disclosure, the first control device and the second control device may be each provided with a predetermined level of security measures. As described above, the security of the charger can be more sufficiently protected.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a vehicle 20 according to the present embodiment;

FIG. 2 is a schematic configuration diagram of the vehicle 20B of the comparative form.

### DETAILED DESCRIPTION OF EMBODIMENTS

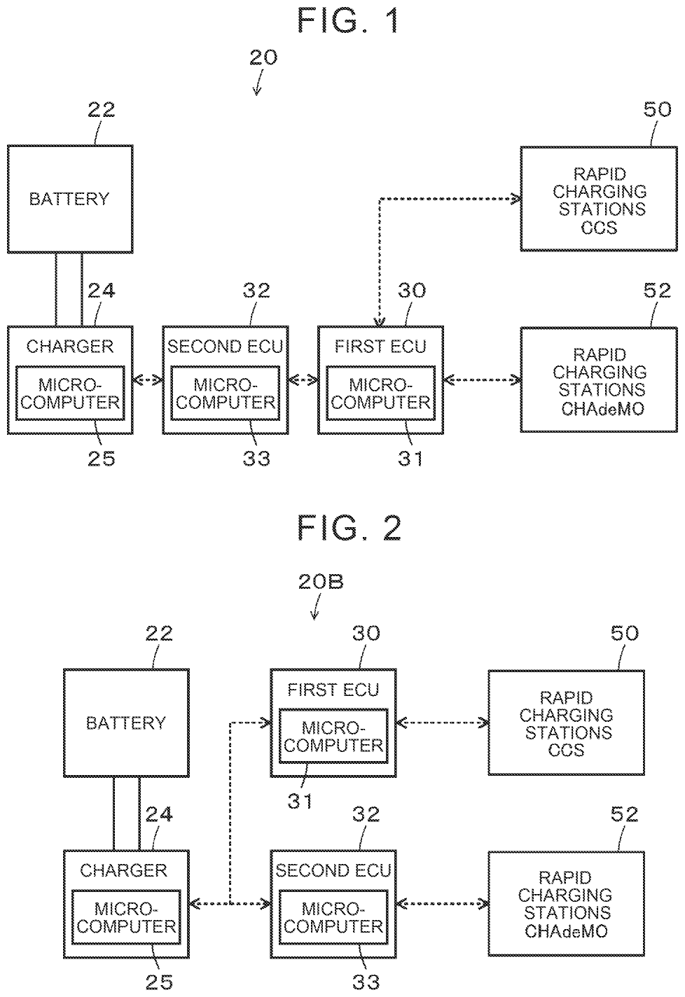

Embodiments of the present disclosure will be described with reference to the drawings. FIG. 1 is a schematic configuration diagram of a vehicle 20 according to the present embodiment. The vehicles 20 are configured as, for example, a battery electric vehicle or a hybrid electric vehicle, fuel cell electric vehicle including a driving motor.

As illustrated, the vehicle 20 includes a battery 22 as a power storage device for exchanging electric power with a driving motor, a charger 24 used for charging the battery 22, a first electronic control unit 30, and a second electronic control unit 32. Hereinafter, the first electronic control unit 30 and the second electronic control unit 32 are also referred to as “first ECU, second ECU”.

Vehicle 20 is configured to perform rapid charging (DC charging) when connected to a rapid charging station (DC charging station) 50 conforming to the charging standard of Combined Charging System (CCS) or when connected to a rapid charging station (DC charging station) 52 conforming to the charging standard of CHAdeMO (registered trademark). In quick charging (DC charging), the battery 22 is charged using relatively large DC power from the rapid charging station 50 or the rapid charging station 52. The rapid charging stations 50 and 52 are installed in a home, a charging station, or the like, respectively.

The vehicle 20 is configured to perform normal charging (AC charging) when connected to an AC charging station. The AC charging station is configured to be the same as or separate from the rapid charging stations 50 and 52 and to be capable of outputting AC power. In normal charging (AC charging), the battery 22 is charged by the charger 24 using AC power from an AC charging station. The AC charging station is installed at a home or a charging station.

The battery 22 is configured as, for example, a lithium-ion secondary battery or a nickel-hydrogen secondary battery. The charger 24 is configured to convert AC power from the AC charging station into DC power and supply the DC power to the battery 22. The charger 24 includes a power factor adjusting circuit and DC/DC converters, a microcomputer (hereinafter, referred to as “microcomputer”) 25 for controlling these. The microcomputer 25 includes a CPU, ROM, RAM, a flash memory, an input/output port, and a communication port.

The first ECU 30 includes a microcomputer 31 similar to the microcomputer 25. The first ECU 30 performs wired communication with the second ECU 32 via a communication line. The first ECU 30 may also communicate with a rapid charging station 50 compliant with CCS charging standard or a rapid charging station 52 compliant with CHAdeMO charging standard. When communicating with the rapid charging station 50, the first ECU 30 performs wired communication and wireless communication via a communication line. When communicating with the rapid charging station 52, the first ECU performs wired communication via a communication line. The microcomputer 31 is provided with a predetermined level (sufficiently high) of security measures. As a defense in security measures at a predetermined level, for example, separation of target information such as software from unauthorized access from the outside of the vehicle, prohibition of read access from the outside of the vehicle, and the like are exemplified.

The second ECU 32 includes a microcomputer 33 similar to the microcomputer 25. The second ECU 32 performs wired communication with the charger 24 via a communication line, and performs wired communication with the first ECU 30 via a communication line. That is, the second ECU 32 does not directly communicate with the outside of the vehicle, for example, the rapid charging stations 50 and 52. As with the microcomputer 31, the microcomputer 33 performs security measures at a predetermined level. The microcomputer 33 may be formed on the same substrate as the microcomputer 31, or may be formed on different substrates.

Here, the vehicle 20B of the comparative mode will be described. The vehicle 20B of the comparative mode differs from the vehicle 20 of the present embodiment in that the charger 24, first ECU 30, and second ECU 32 perform wired communication via a communication line, and that the second ECU 32 performs communication with the rapid charging station 52 compliant with the charging standard of CHAdeMO (registered trademark) instead of first ECU 30.

In the vehicle 20 of the present embodiment and the vehicle 20B of the comparative embodiment, when the vehicle 20,20B and the rapid charging stations 50 and 52 communicate with each other, the microcomputers of the vehicle 20,20B need to be exposed to an attack (unauthorized access) from the outside of the vehicle. In particular, it is necessary to consider a concern that the microcomputer in the first layer and the second layer from the entry point is exposed to an attack (unauthorized access) from the outside of the vehicle. Moreover, when information having a sufficiently high risk rank exists in these microcomputers, it is necessary to consider the risk of information tampering. In the vehicle 20B of the comparative mode, in the communication between the vehicle 20B and the rapid charging station 50, the first layer from the entry point in the vehicle 20B is the microcomputer 31 of the first ECU 30, and the second layer is the microcomputer 25 of the charger 24. Further, in the communication between the vehicle 20B and the rapid charging station 52, the first layer from the entry point in the vehicle 20B is the microcomputer 33 of the second ECU 32, and the second layer is the microcomputer 25 of the charger 24. Therefore, in addition to the microcomputer 31 of the first ECU 30 and the microcomputer 33 of the second ECU 32, the microcomputer 25 of the charger 24 needs to be security-protected. This may lead to a large increase in cost. On the other hand, in the vehicle 20 of the present embodiment, in the communication between the vehicle 20 and the rapid charging stations 50 and 52, the microcomputer 31 of the first ECU 30 from the entry point in the vehicle 20, the microcomputer 33 of the second ECU 32, and the microcomputer 25 of the charger 24 are the third layer. This makes it possible to protect the security of the microcomputer 25 of the charger 24 even if the microcomputer 25 of the charger 24 does not take security measures at a predetermined level as compared with the vehicle 20B of the comparative mode. That is, it is possible to secure the microcomputer 25 of the charger 24 while suppressing an increase in cost.

The vehicle 20 of the present embodiment described above includes the microcomputer 25 of the charger 24, the microcomputer 31 of the first ECU 30, and the microcomputer 33 of the second ECU 32, and is capable of rapid charging (DC charging) and normal charging (AC charging). The first ECU 30 communicates with the rapid charging stations 50, 52. The second ECU 32 communicates with the charger 24 and with the first ECU 30. Therefore, in the communication between the vehicle 20 and the rapid charging stations 50 and 52, the microcomputer 31 of the first ECU 30 from the entry point in the vehicle 20, the microcomputer 33 of the second ECU 32, and the microcomputer 25 of the charger 24 are the third layer. Thus, compared to the case where the second layer from the entry point becomes the microcomputer 25 of the charger 24, it is possible to secure the microcomputer 25 of the charger 24 without performing security measures of a predetermined level to the microcomputer 25 of the charger 24. That is, it is possible to secure the microcomputer 25 of the charger 24 while suppressing an increase in cost.

In the above-described embodiment, the vehicles 20 are supposed to be capable of complying with CCS and CHAdeMO (registered trademark) charge standards. However, the present disclosure is not limited to this, and the vehicles 20 may be compatible with GB/T and the like.

In the above-described embodiment, the battery 22 is used as the power storage device mounted on the vehicle 20. However, a capacitor or the like may be used as the power storage device mounted on the vehicle 20.

The correspondence between the main elements of the embodiment and the main elements of the disclosure described in SUMMARY will be described. In the embodiment, the charger 24 corresponds to a “charger”, the first ECU 30 corresponds to a “first control device”, and the second ECU 32 corresponds to a “second control device”.

Note that the correspondence between the main elements of the embodiment and the main elements of the disclosure described in the section of the means for solving the problem is an example for specifically explaining the embodiment of the disclosure described in the section of the means for solving the problem, and therefore the elements of the disclosure described in the section of the means for solving the problem are not limited. That is, the interpretation of the disclosure described in the section of the means for solving the problem should be performed based on the description in the section, and the embodiments are only specific examples of the disclosure described in the section of the means for solving the problem.

Although the embodiments for carrying out the present disclosure have been described above, the present disclosure is not limited to such embodiments at all, and it is needless to say that the present disclosure can be carried out in various forms without departing from the gist of the present disclosure.

The present disclosure is applicable to a manufacturing industry of a vehicle and the like.

What is claimed is:

1. A vehicle that is able to perform direct current charging for charging a power storage device using direct current power from a direct current charging station and alternating current charging for charging the power storage device by converting alternating current power from an alternating current charging station into direct current power with a charger, the vehicle comprising:
a charger used for charging the power storage device;
a first control device; and
a second control device, wherein:
the first control device communicates with the charging station; and
the second control device communicates with the charger and communicates with the first control device.

2. The vehicle according to claim 1, wherein the first control device and the second control device are each provided with a predetermined level of security measures.
